(19) United States
(12) Patent Application Publication
(10) Pub. No.: US 2009/0324095 A1
(43) Pub. Date: Dec. 31, 2009

(54) ANALYSIS-MODEL-PRODUCING APPARATUS AND ANALYSIS-MODEL-PRODUCING METHOD

(75) Inventors: Makoto Sakairi, Kawasaki (JP); Nobutaka Itoh, Kawasaki (JP); Yoshiteru Ochi, Kawasaki (JP); Yoko Kobayashi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/555,998

(22) Filed: Sep. 9, 2009

Related U.S. Application Data
(63) Continuation of application No. PCT/JP2007/000272, filed on Mar. 20, 2007.

(51) Int. Cl. G06K 9/46

(52) U.S. Cl. 382/203

(57) ABSTRACT

An analysis-model-producing apparatus for producing an analysis model from a shape model, comprising means for specifying a deletion method for deleting, from geometric shape data constituting the shape model, geometric shape data that is unnecessary to production of an analysis model, and means for deleting unnecessary data, using the specified deletion method.

### CROSS-REFERENCE TO RELATED APPLICATION

This application is based upon and claims the benefit of priority of the prior Japanese Patent Application No. PCT/JP2007/000272, filed on Mar. 20, 2007, the entire contents of which are incorporated herein by reference.

### FIELD

The embodiments discussed herein are related to a CAE (Computer Aided Engineering) system that simulates physical phenomena by means of numerical analysis, and more particularly to an analysis-model-producing apparatus and an analysis-model-producing method for producing, from a shape model to be analyzed, an analysis model used in a numerical analysis.

### BACKGROUND

CAD (Computer Aided Design) systems have been in widespread use for designing various structures with the aid of computers.

Also, the spread of CAD systems has made CAE systems common for producing numerical analysis models from a shape model of a designed structure in order to perform simulation of various physical phenomena on computers.

Large structures or very complex structures are made of an enormous number of parts, resulting in an enormous number of pieces of geometric shape data as constituent elements of the shape models. A numerical analysis of such structures requires that whether or not geometric shape data is necessary be determined for each of the pieces of the geometric shaped data in accordance with the content of the numerical analysis so that a numerical analysis model can be produced without using unnecessary data.

Conventionally, system users of have determined whether or not geometric shape data is necessary for each of an enormous number of pieces of the geometric shape data constituting a shape model in accordance with the content of a numerical analysis in order to input whether such pieces of data are to be used or discarded in a one-by-one manner when producing numerical analysis models. This has required a very long period of time for completing numerical analysis model productions, which is problematic.

Several systems for assisting users of CAE systems are proposed.

Japanese Laid-open Patent Publication No. 2001-265836 discloses a configuration in which jointing portions are emphasized in a display for system users when an analysis model is produced because jointing portions need to be expressed appropriately, and thereby a highly accurate analysis can be realized for the production of the analysis model from the shape model having various jointing portions.

Japanese Laid-open Patent Publication No. 2003-233648 discloses a system that estimates types of processing machine and the number of processing steps required for each of such processing machines that are used for processing parts. This processing estimation system selects a shape model similar to the entire shape of an estimation target part, determines types of processing machine and the number of processing steps for each of the processing machines required to produce the shape model, selects a detailed shape model similar to the shape of a part that needs further processing on the basis of the selected shape model, and determines types of processing machine and the number of process steps required for each of the processing machines that are to be added. This system allows even inexperienced personnel to estimate types of processing machine and the number of process steps for each of the processing machines required for producing an estimation target part just by performing simple operations on computers.

However, no document has ever proposed a system that assists system users in determining whether or not each piece of geometric shape data, as a constituent element of a shape model, is necessary in accordance with the content of a numerical analysis and in specifying whether or not each of such pieces of data is to be used when producing an analysis model from a shape model and performing a numerical analysis.

### SUMMARY

An apparatus according to an aspect of the present invention is an analysis-model-producing apparatus for producing an analysis model from a shape model, including means for specifying a condition for determining whether each piece of geometric shape data constituting the shape model is necessary or unnecessary for producing an analysis model, and means for deleting geometric shape data that is determined by the specified condition to be unnecessary.

Thereby, the system user can specify a condition for deleting unnecessary geometric shape data from geometric shape data constituting a shape model according to the content of a numerical analysis, and also can extract only necessary geometric shape data in accordance with the specified condition. This leads to an increase in operations performed by the system user to produce an analysis model from a shape model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the outline of a process performed by an analysis-model-producing apparatus according to the present invention;

FIG. 2 is a functional block diagram illustrating an analysis-model-producing apparatus according the present invention;

FIG. 3 illustrates a detailed configuration of a GUI unit;

FIG. 4 illustrates the flow of a process performed by an analysis-model-producing apparatus according the present invention;

FIG. 5 illustrates an embodiment of an analysis-model-producing apparatus according to the present invention;

FIG. 6A illustrates a data structure of a CAD part data storage unit 504;

FIG. 6B illustrates a data structure of an analysis-model-producing CAD part data storage unit 509;

FIG. 7 illustrates a detailed structure of a CAD part data discrimination unit 505;

FIG. 8 illustrates an example of a window displayed by a GUI unit 506 in an analysis-model-producing apparatus according to an embodiment of the present invention;

FIG. 9 illustrates a flow of a process performed by an analysis-model-producing apparatus according to an embodiment of the present invention;

FIG. 10 illustrates a flow of a process performed when “name (drawing number)” is selected as a deletion method (S905);

FIG. 11 illustrates an example of a displayed window (initial state);

FIG. 12 illustrates an example of a displayed window (inputting deletion condition (name));

FIG. 13 illustrates an example of a displayed window (displaying a list and displaying parts in a highlighted manner);

FIG. 14 illustrates an example of a displayed window (final confirmation and state after deletion);

FIG. 15 illustrates a flow of a process performed when “part size” is selected as a deletion method (S906);

FIG. 16 illustrates an example of a displayed window (inputting deletion condition (part size));

FIG. 17 illustrates a flow of a process performed when “physical property value” is selected as a deletion method (S907);

FIG. 18 illustrates an example of a displayed window (inputting deletion condition (physical property value));

FIG. 19 illustrates a flow of a process performed when “weight” is selected as a deletion method (S908);

FIG. 20 illustrates an example of a displayed window (inputting deletion condition (weight));

FIG. 21 illustrates a flow of a process performed when “similar parts” is selected as a deletion method (S909);

FIG. 22 illustrates an example of a displayed window (message for specifying a basic part);

FIG. 23 illustrates an example of a displayed window (pop-up window for specifying a similarity determination method);

FIG. 24 illustrates a configuration of an information processing apparatus for implementing an analysis-model-producing apparatus; and

FIG. 25 illustrates the loading of programs onto an information processing apparatus.

### DESCRIPTION OF EMBODIMENTS

Hereinafter, embodiments of the present invention will be explained by referring to the drawings.

An analysis-model-producing apparatus according to the present invention produces an analysis model from a shape model.

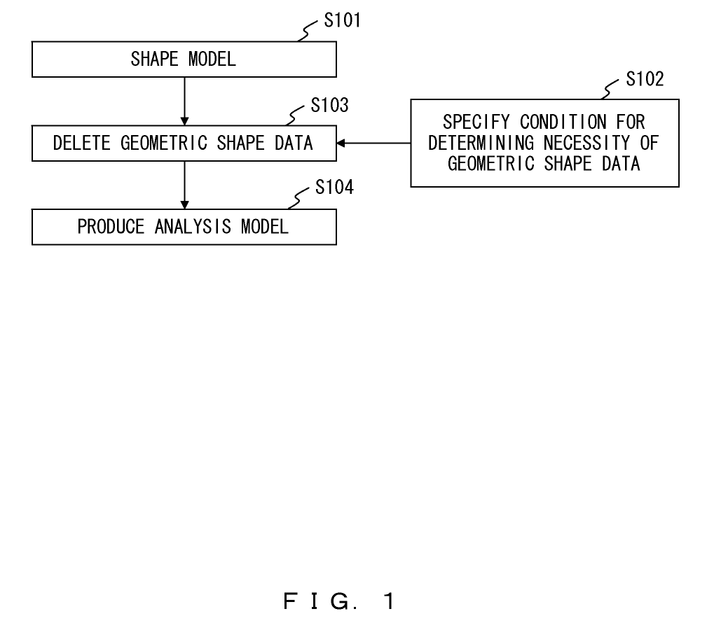

FIG. 1 illustrates the outline of a process performed by an analysis-model-producing apparatus according to the present invention.

A condition is specified (S102) for determining whether or not geometric shape data constituting a shape model (S101) such as a structure produced by a CAD tool or the like is necessary for producing an analysis model. Next, on the basis of the condition, whether or not the geometric shape data is necessary is determined in order to perform a geometric shape data deletion process on the basis of the determination result, and only geometric shape data that is necessary for producing an analysis model is output (S103). An analysis model is produced on the basis of the output data (S104).

The present invention corrects the aspect of conventional systems in which users have confirmed each piece of geometric shape data in order to specify whether it is necessary, and performs processes in S102 and S103 by using an analysis-model-producing apparatus in order to assist the users.

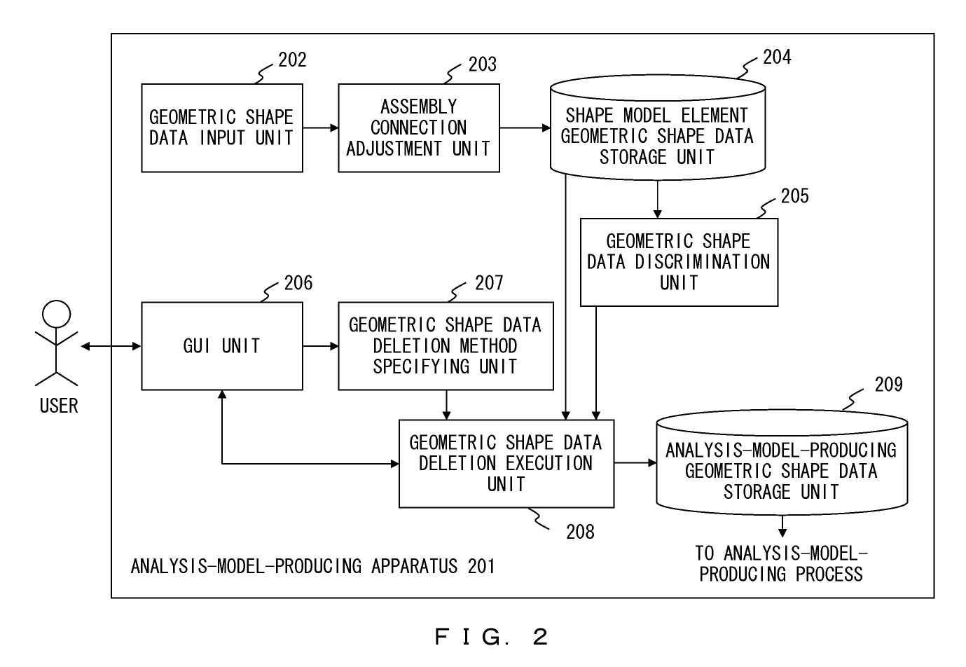

FIG. 2 illustrates a configuration of the portion performing the processes in S102 and S103 in an analysis-model-producing apparatus according to the present invention. Note that a piece of geometric shape data described herein includes a group of pieces of detailed information on individual parts of a structure, such as name, size, physical property value, weight, positional coordinates, and the like.

First, each piece of geometric shape data constituting the shape model is input through a geometric shape data input unit 202. An assembly connection adjustment unit 203 adjusts the connections between the pieces of geometric shape data so that the connections are not broken. Specifically, a process is performed to change relative expressions of positional coordinates into absolute expressions so that even when one of the pieces of geometric shape data having a positional coordinate expressed relatively between them is deleted, the positional coordinates of the remaining piece of geometric shape data can be determined.

Each piece of the input geometric shape data constituting the shape model is stored in a shape model element geometric shape data storage unit 204.

Thereafter, the user uses a GUI (Graphical User Interface) unit 206 to input the geometric shape data deletion condition in accordance with the numerical analysis content. The input geometric shape data deletion condition is stored in a geometric shape data deletion method specifying unit 207. Then, a geometric shape data deletion execution unit 208 refers to the condition in the geometric shape data deletion method specifying unit 207 in order to make a geometric shape data discrimination unit 205 extract the geometric shape data that corresponds to the condition from the shape model element geometric shape data storage unit 204.

The geometric shape data deletion execution unit 208 reflects the result output from the geometric shape data discrimination unit 205 on the GUI unit 206 to display the result on a screen or the like in order to obtain confirmation from the user that the displayed data can be assuredly deleted, and deletes the corresponding geometric shape data from the shape model element geometric shape data storage unit 204. Thereafter, the geometric shape data deletion execution unit 208 stores only remaining geometric shape data in an analysis-model-producing geometric shape data storage unit 209.

Then, an analysis model is produced from the geometric shape data stored in the analysis-model-producing geometric shape data storage unit 209.

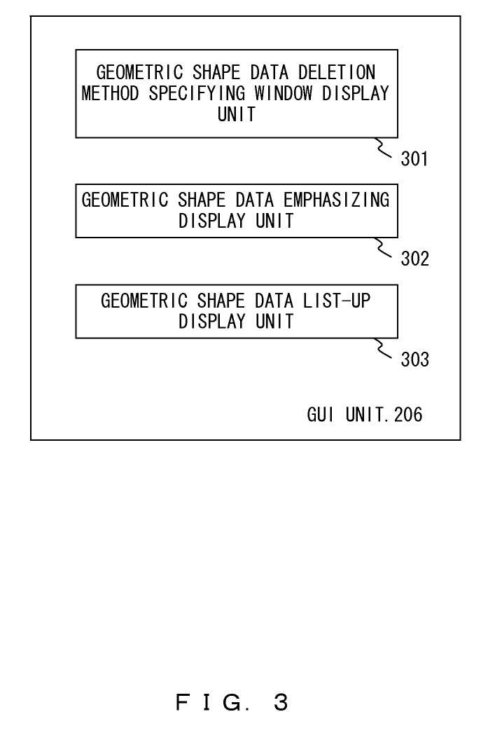

FIG. 3 illustrates a detailed configuration of the GUI unit 206 in an analysis-model-producing apparatus 201. The GUI unit 206 includes a geometric shape data deletion method specifying window display unit 301 for displaying a window used for specifying a method of deleting geometric shape data, a geometric shape data emphasizing display unit 302 for highlighting or blinking geometric shape data to be deleted (for example in a window displaying the shape model), and a geometric shape data list-up display unit 303 for displaying on a screen geometric shape data to be deleted in a listed manner.

Thereby, the system user can use the GUI unit 206 to input and specify, in the analysis-model-producing apparatus 201, a condition for deleting geometric shape data, and also can confirm geometric shape data that meets the deletion condition in the shape model display window and view a plurality of pieces of geometric shape data meeting the deletion condition displayed in a listed manner, which leads to an increase in the efficiency in operations of deleting geometric shape data.

Hereinafter, embodiments of an analysis-model-producing apparatus according to the present invention will be described in order to explain the present invention in more detail.

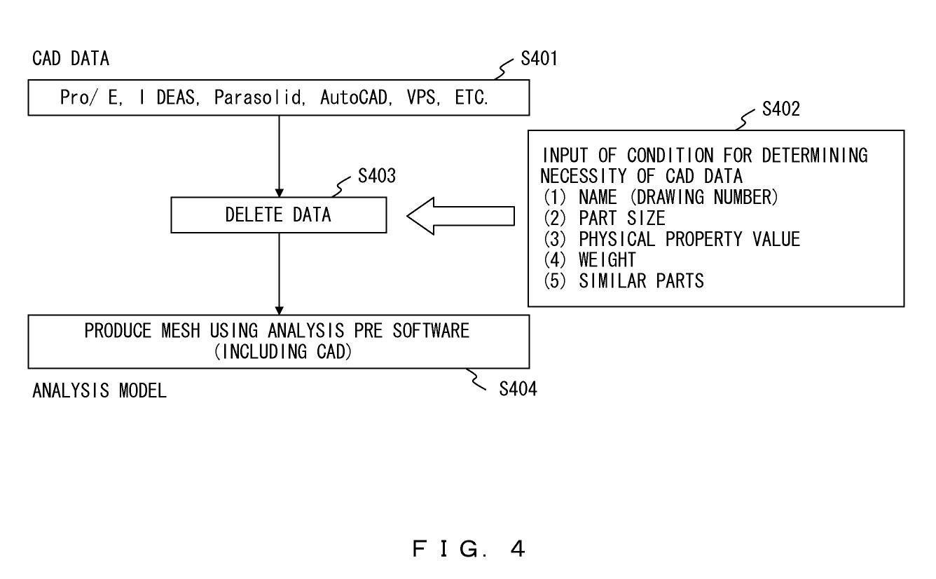

FIG. 4 illustrates the outline of an analysis-model-producing apparatus in an embodiment of the present invention.

A condition is specified for determining whether or not each piece of CAD part data is necessary for producing an analysis model (S402) of CAD data (S401) of a structure or the like produced using a CAD tool such as Pro/E (a registered trademark or a trademark of Parametric Technology Corporation (PTC) of U.S.A. in and out of U.S.A.), I DEAS (a registered trademark or a trademark of UGS of U.S.A. in and out of U.S.A.), Parasolid (a registered trademark or a trademark of UGS of U.S.A. in and out of U.S.A.), AutoCAD (a registered trademark or a trademark of AutoDesk of U.S.A. in and out of U.S.A.), VPS (a registered trademark or a trademark of Fujitsu in and out of Japan), or the like. Examples of methods of specifying a condition for deleting CAD part data include: (1) specifying name; (2) specifying part size; (3) specifying a property value; (4) specifying weight; and (5) specifying similar parts.

Next, whether or not each piece of CAD part data is necessary is determined on the basis of the condition, a CAD part data deletion process is performed on the basis of the determination result, and only CAD part data necessary for producing the analysis model is output (S403). The analysis model is produced by an analysis pre software producing a mesh on the basis of the output CAD part data (S404).

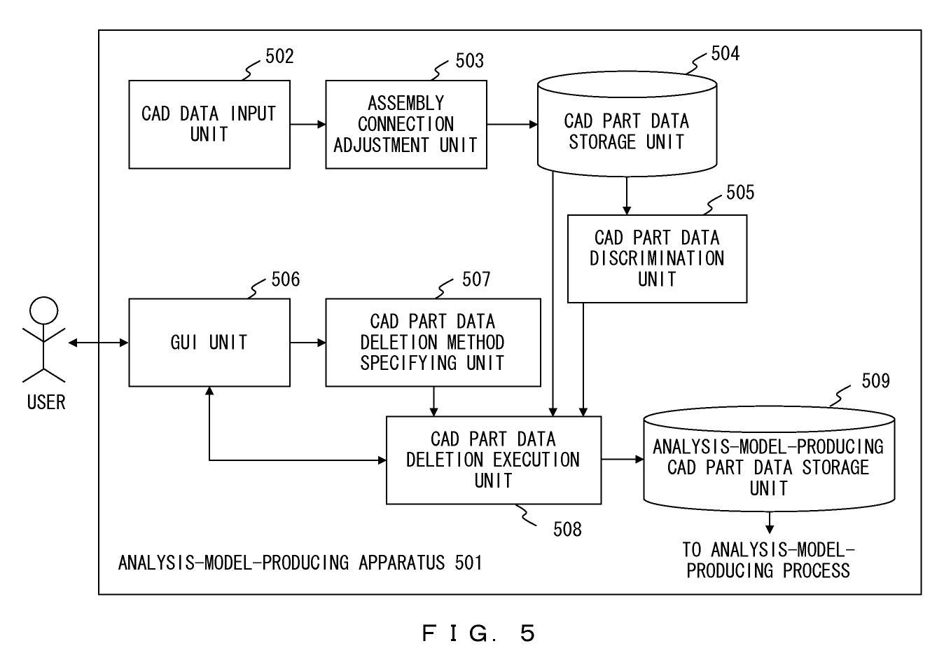

FIG. 5 illustrates the portion performing the processes in S402 and S403 in an analysis-model-producing apparatus according to an embodiment of the present invention.

First, CAD data as the design data of a structure or the like is input through a CAD data input unit 502. Next, the input data is adjusted by the assembly connection adjustment unit 503 so that the connections between the pieces of CAD part data are not broken. In a case of including an assembly having plural parts as CAD part data, the positional coordinates between parts are sometimes expressed in a relative manner, and in such a case, a process is performed to change relative expressions into absolute expressions so that even when one of the pieces of CAD part data having positional coordinates expressed in a relative manner between them is deleted, the positional coordinates of the remaining piece of geometric shape data can be determined.

The CAD data of the structure thus input is stored in a CAD part data storage unit 504.

Thereafter, the user uses a GUI (Graphical User Interface) unit 506 to input the CAD part data deletion condition in accordance with the numerical analysis content. The input CAD part data deletion condition is stored in a CAD part data deletion method specifying unit 507. Then, a CAD part data deletion execution unit 508 refers to the condition in the CAD part data deletion method specifying unit 507 in order to make a CAD part data discrimination unit 505 extract CAD part data that corresponds to the condition.

The CAD part data deletion execution unit 508 reflects the result output from the CAD part data discrimination unit 505 on the GUI unit 506 so as to display it in a window or the like in order to obtain confirmation from the user that the displayed data can assuredly be deleted, and deletes the corresponding CAD part data from the CAD part data storage unit 504. Thereafter, the CAD part data deletion execution unit 508 stores only remaining CAD part data in an analysis-model-producing CAD part data storage unit 509.

Thereafter, an analysis model is produced from the CAD part data stored in the analysis-model-producing CAD part data storage unit 509.

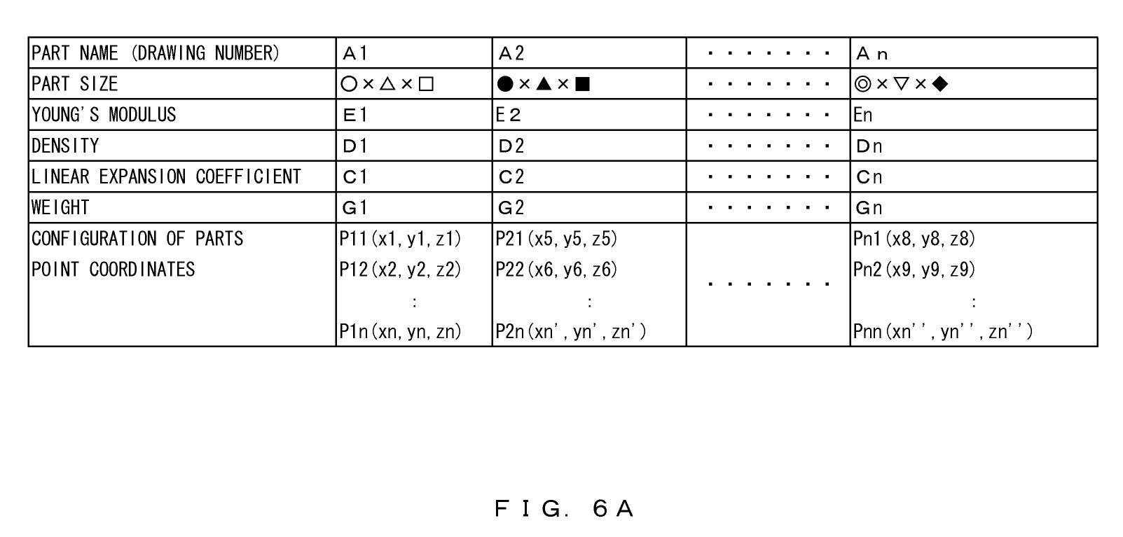

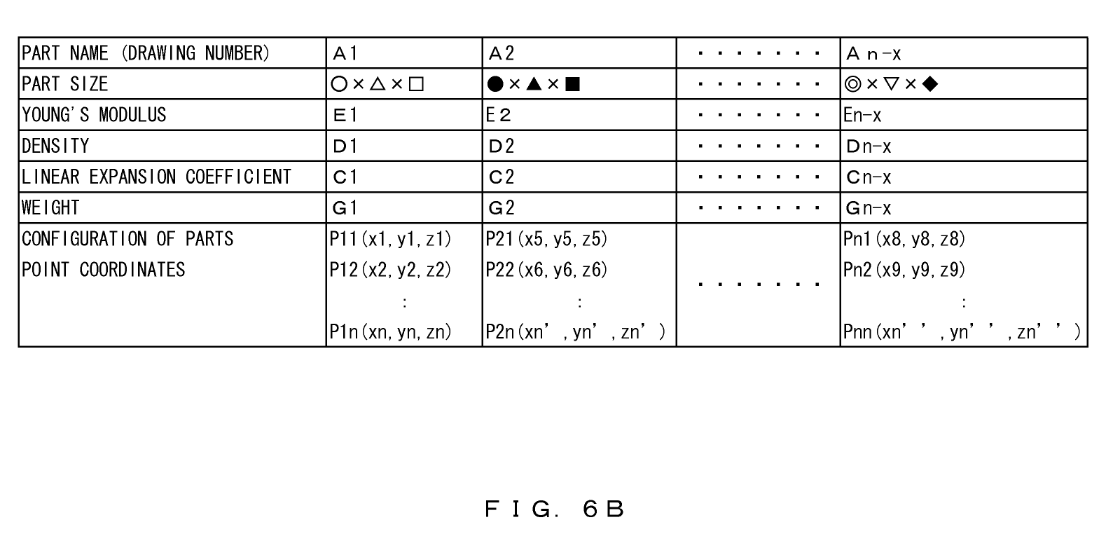

FIG. 6A illustrates an example of a data structure in the CAD part data storage unit 504. FIG. 6B illustrates an example of a data structure in the analysis-model-producing CAD part data storage unit 509. In both of them, each of the pieces of CAD part data is formed from part name, part size, physical property value (such as a Young's modulus, density, and a linear expansion coefficient), weight, and part configuration point coordinates. FIG. 6B illustrates data for producing an analysis model, and accordingly the numbers of the CAD part data in FIG. 6B are less than their counterparts in FIG. 6A by the number, x in this case, of pieces of data deleted in the deletion process.

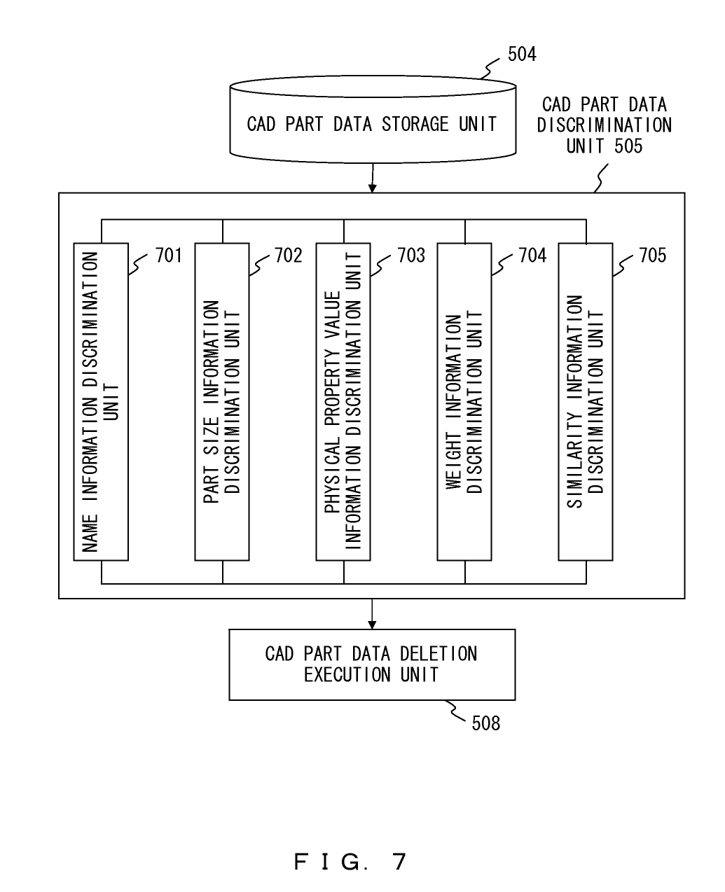

FIG. 7 illustrates a detailed structure of the CAD part data discrimination unit 505.

The CAD part data discrimination unit 505 includes a name information discrimination unit 701, a part size information discrimination unit 702, a physical property value information discrimination unit 703, a weight information discrimination unit 704, and a similarity information discrimination unit 705. The name information discrimination unit 701 searches the area containing names of parts in the CAD part data storage unit 504 so as to output the corresponding data when the name of a part is specified as a condition for deleting CAD part data. The part size information discrimination unit 702 searches the area containing sizes of parts in the CAD part data storage unit 504 so as to output the corresponding data when the size of a part is specified as a condition for deleting CAD part data. The physical property value information discrimination unit 703 searches the area containing physical property values in the CAD part data storage unit 504 so as to output the corresponding value when a physical property value is specified as a condition for deleting CAD part data. The weight information discrimination unit 704 searches the area containing weight in the CAD part data storage unit 504 so as to output the corresponding data when the weight of a part is specified as a condition for deleting CAD part data. The similarity information discrimination unit 705 outputs similar CAD part data from the CAD part data storage unit 504 when data similar to a particular piece of CAD part data is specified as a condition for deleting CAD part data.

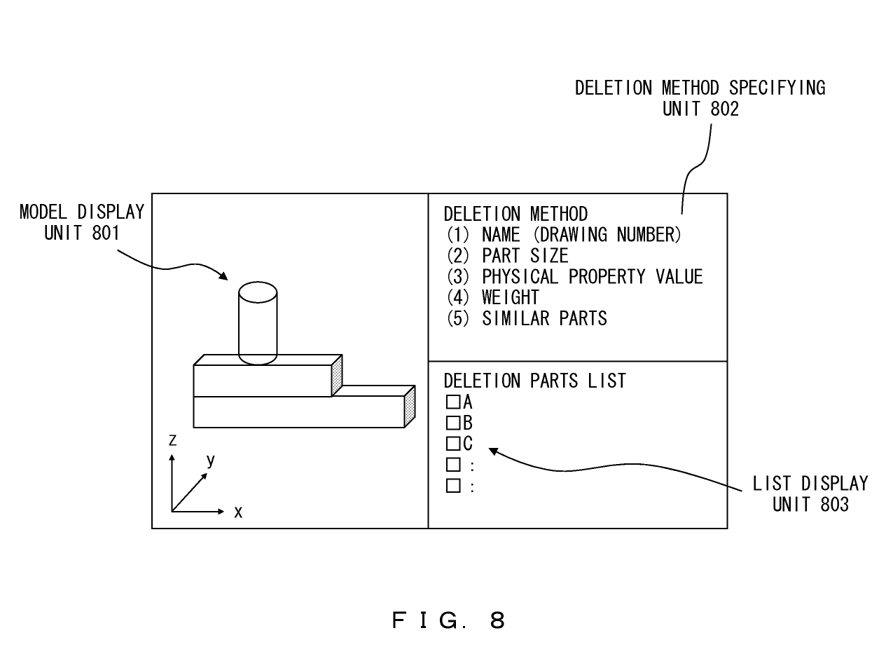

The GUI unit 506 is configured similarly to that in FIG. 3, and an example of windows displayed by the GUI unit 506 is illustrated in FIG. 8. Specifically, a window for displaying a shape model of a structure (a model display unit 801), a window for specifying a method of deleting CAD part data (a deletion method specifying unit 802), and a window for displaying CAD part data meeting the deletion condition in a listed manner (a list display unit 803) are displayed.

The model display unit 801 can display the CAD part data meeting the deletion condition in a highlighted manner so that the users can notice them. Also, the system users can check boxes that correspond to listed plural pieces of CAD part data or leave such boxes unchecked in order to give final instructions on whether or not to delete the CAD part data.

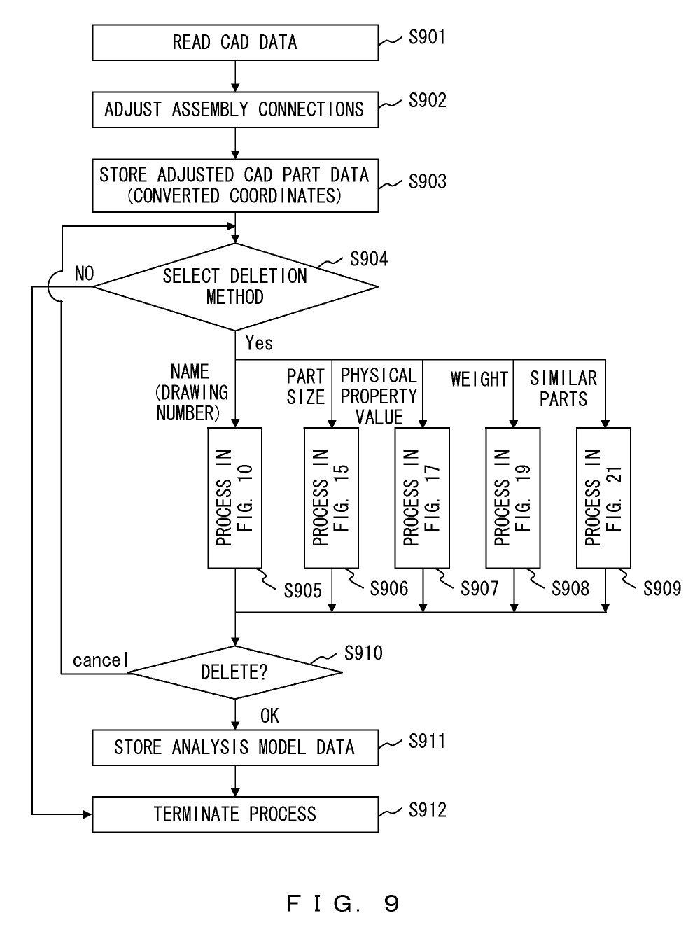

Hereinabove, the configuration of an analysis-model-producing apparatus according to an embodiment of the present invention has been explained by referring to FIGS. 4 through 8. Next, operations of the analysis-model-producing apparatus will be explained further by referring to the flowcharts illustrated in FIGS. 9 through 23.

FIG. 9 illustrates a main flowchart for an analysis-model-producing apparatus according to an embodiment of the present invention.

First, the CAD data input unit 502 reads CAD data corresponding to a shape model of a structure or the like in S901.

In S902, a process is performed to maintain the connections when assemblies are included in the data read by the assembly connection adjustment unit 503. Specifically, when there are positional coordinates expressed in a relative manner between pieces of CAD part data, the relative expression is adjusted and changed into an absolute expression so that even if one of such pieces is deleted, the positional coordinates of the remaining piece of CAD part data can be determined.

In S903, the adjusted CAD part data is stored in the CAD part data storage unit 504.

In S904, the system user uses the GUI unit 506 to select a deletion method.

Deletion methods include a method in which a deletion condition is specified by specifying the name of a part (or drawing number), a method in which a deletion condition is specified by specifying the size of a part, a method in which a deletion condition is specified by specifying the physical property value of a part, a method in which a deletion condition is specified by specifying the weight value of a part, a method in which a deletion condition is specified by specifying a similar part, and the like, and the user selects one of these methods.

When a deletion method is not selected in S904, the process proceeds to S912 to terminate the process.

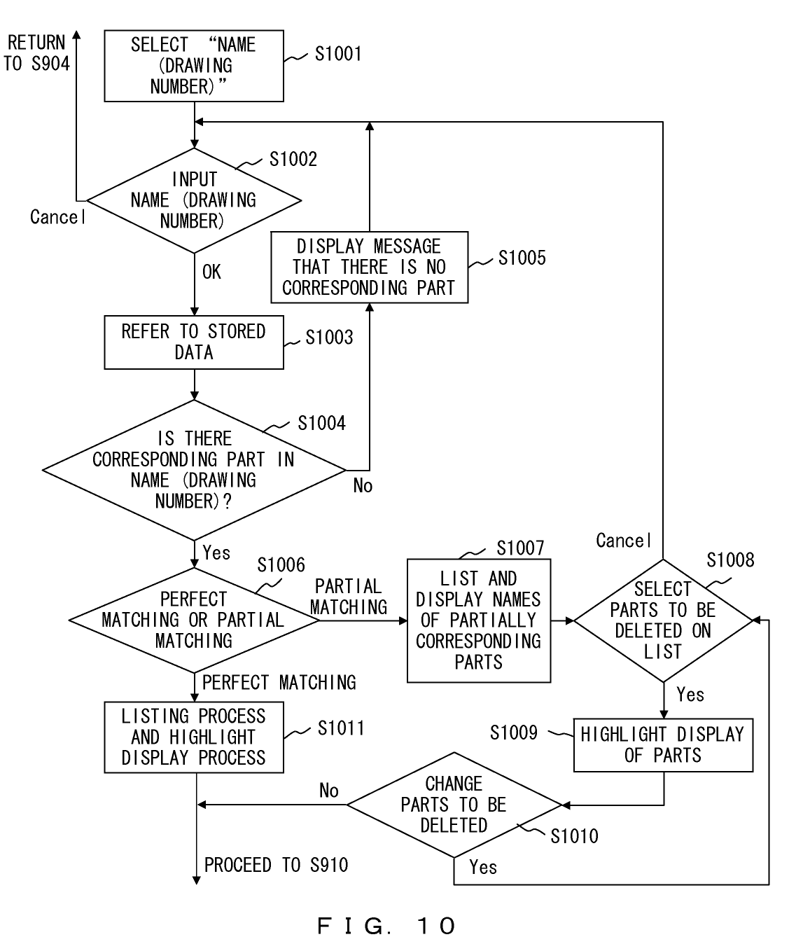

When a method in which a deletion method is specified by a name of a part is selected in S904, the process proceeds to S905. S905 will be explained later in detail by referring to FIG. 10.

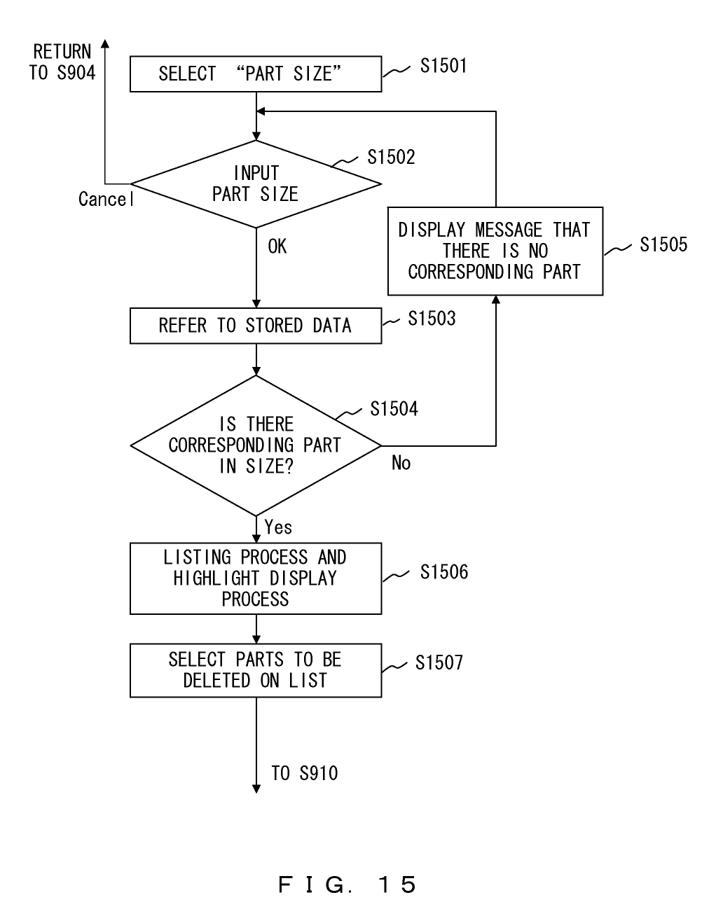

When a method in which a deletion condition is specified by the size of a part is selected in S904, the process proceeds to S906. S906 will be explained later in detail by referring to FIG. 15.

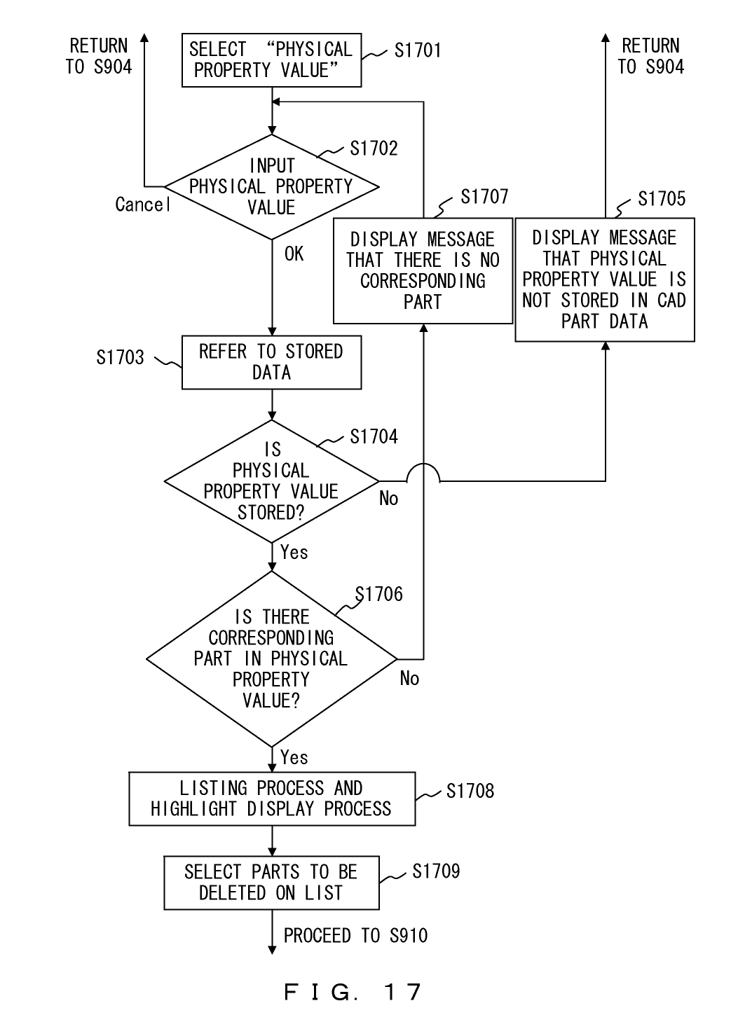

When a method in which a deletion condition is specified by the physical property value of a part is selected in S904, the process proceeds to S907. S907 will be explained later in detail by referring to FIG. 17.

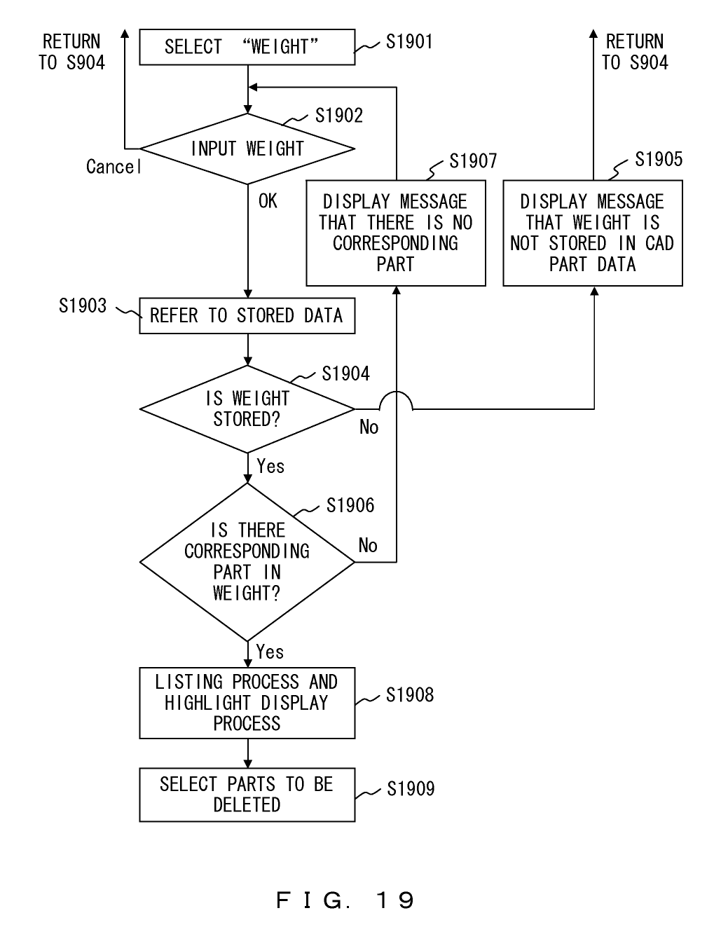

When a method in which a deletion condition is specified by the weight value of a part is selected in S904, the process proceeds to S908. S908 will be explained later in detail by referring to FIG. 19.

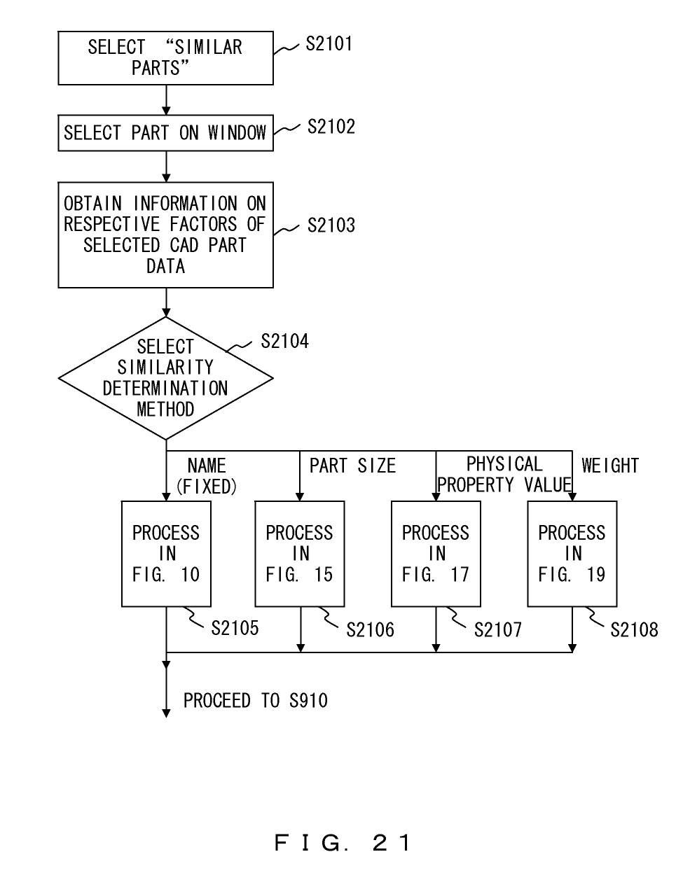

When a method in which a part similar to a specified part is deleted is selected in S904, the process proceeds to S909. S909 will be explained later in detail by referring to FIG. 21.

When the processes in S905, S906, S907, S908, and S909 are terminated, the process proceeds to S910. When an instruction to execute the deletion is given by the system user using the GUI unit 506 in S910 (Yes), the process proceeds to S911. When the system user cancels the execution of the deletion (Cancel) in S910, the process returns to S904.

In S911, CAD part data remaining after deleting, from the CAD part data storage unit 504, the CAD part data that is unnecessary to production of an analysis model is stored in the analysis-model-producing CAD part data storage unit 509, and the process is terminated in S912.

After the process in S912, an analysis model is produced from the data stored in the analysis-model-producing CAD part data storage unit 509.

The main process performed by an analysis-model-producing apparatus is as described above. Next, the deletion methods specified in S904 will be explained respectively with reference to the drawings.

First, FIGS. 10 through 14 are referred to in order to explain the process performed when the method in which a deletion condition is specified by name (or by the drawing number) (S905) is selected.

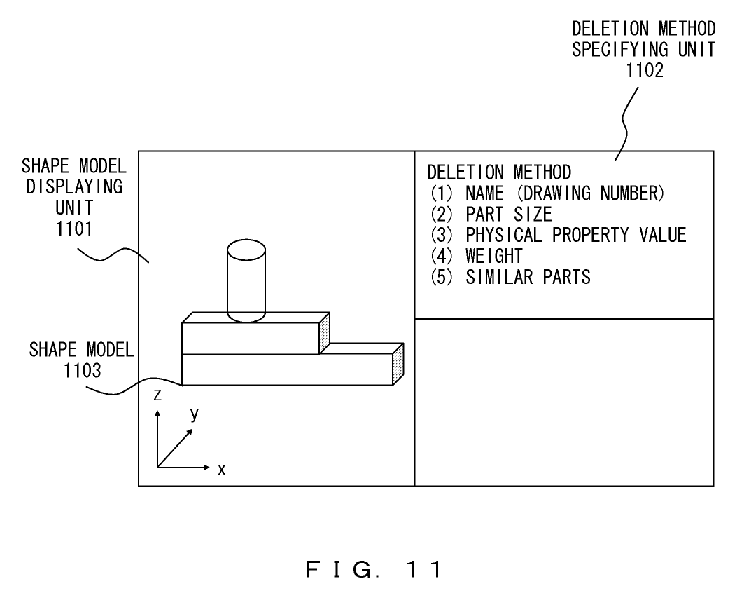

In S1001 in FIG. 10, a deletion method in which a deletion condition is specified by name (or by the drawing number) is selected. FIG. 11 illustrates an example of a window displaying a shape model after the analysis-model-producing apparatus reads the CAD data in S901. The system user selects a portion displaying “(1) name (drawing number)” in the deletion method list displayed in a deletion method specifying unit 1101 in order to select a deletion method in the process in S1001 in the window displayed by the GUI unit 506 in FIG. 11. This selection is made by double clicking or the like using an input device such as a mouse.

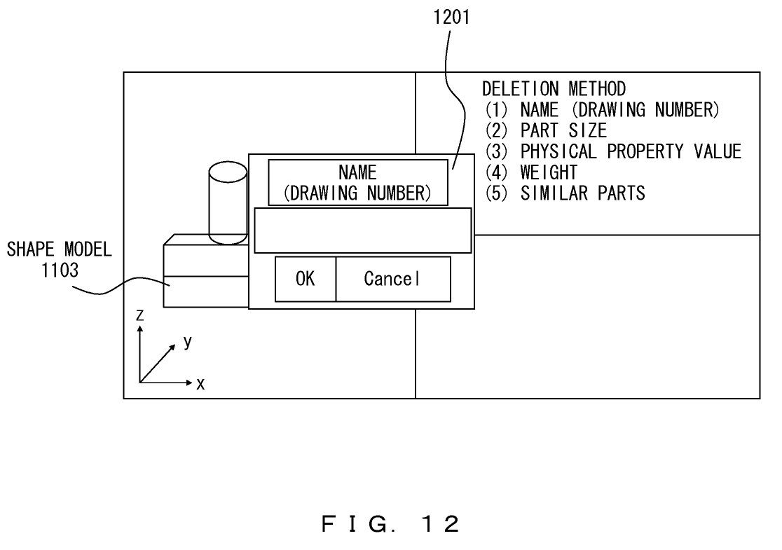

In S1002 in FIG. 10, a pop-up window 1201 is displayed for accepting the input of a name (or drawing number) as illustrated in FIG. 12 so that the system user inputs the name or the drawing number of CAD part data to be deleted. When the OK button is pressed after the input, the name (or the drawing number) of CAD part data specified as a deletion condition is stored in the CAD part data deletion method specifying unit 507, and the process proceeds to S1003. When the Cancel button is pressed in a pop-up window 1201, the process returns to S904.

In S1003 in FIG. 10, the CAD part data deletion execution unit 508 makes the CAD part data discrimination unit 505 extract the CAD part data corresponding to the condition stored in the CAD part data deletion method specifying unit 507 from the CAD part data storage unit 504. In the CAD part data discrimination unit 505, the name information discrimination unit 701 searches the area corresponding to “name of part (drawing number)” in the CAD part data storage unit 504 illustrated in FIG. 6A in order to extract and output the data corresponding to the condition.

In S1004 in FIG. 10, whether or not there is a part corresponding to the name (or the drawing number) is determined, and when there is not (No), the process proceeds to S1005, and the GUI unit 506 displays that there is not a corresponding part, and the process returns to S1001. When there is a corresponding part (Yes), the process proceeds to S1006. When inputting a condition, “*” can be used as a wildcard, and “*” means partial matching of the name (or drawing number), and when “*” is not included, a search is made in a perfect matching condition. In S1006, it is determined whether the search is to be made in a perfect matching condition or a partial matching condition. When a partial matching condition has been selected, the process proceeds to S1007, while when a perfect matching condition has been selected, the process proceeds to S1011.

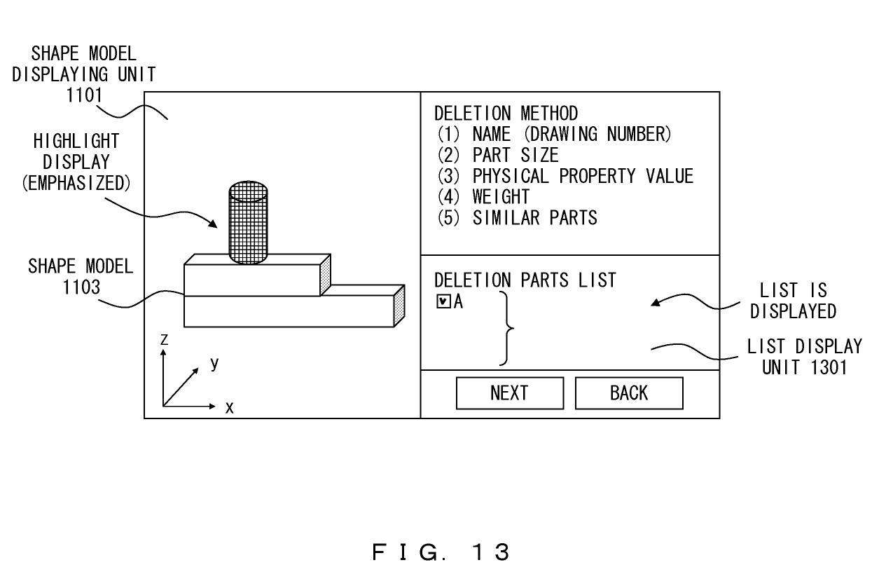

In S1007 in FIG. 10, the GUI unit 506 displays, on a list display unit 1301, parts that partially match the input name in a listed manner as illustrated in FIG. 13. In S1008 in FIG. 10, the system user checks the boxes displayed on the list display unit 1301 in order to specify the parts to be deleted as a final decision. When none of the pieces of CAD part data on the check list is to be deleted (Cancel) in S1008, the process returns to S1001. When at least one of the parts is checked on the check list (Yes), the process proceeds to S1009. As illustrated in FIG. 13, the GUI unit 506 displays, in a highlighted manner, the CAD part data that has been specified to be deleted in the shape model 1103 displayed in the shape model displaying unit 1101, in the order in which it is listed in the list display unit 1301. The system user can confirm the CAD part data specified to be deleted on the shape model, and when the user wants to make a change to such data (Yes in S1010), the process returns to S1008. When there is no change (No), the process proceeds to S910.

In S1011 in FIG. 10, the GUI unit 506 lists the parts that perfectly match the input name in the list display unit 1301 as illustrated in FIG. 13, and also displays the corresponding CAD part data in a highlighted manner in a shape model 1103, and the process proceeds to S910.

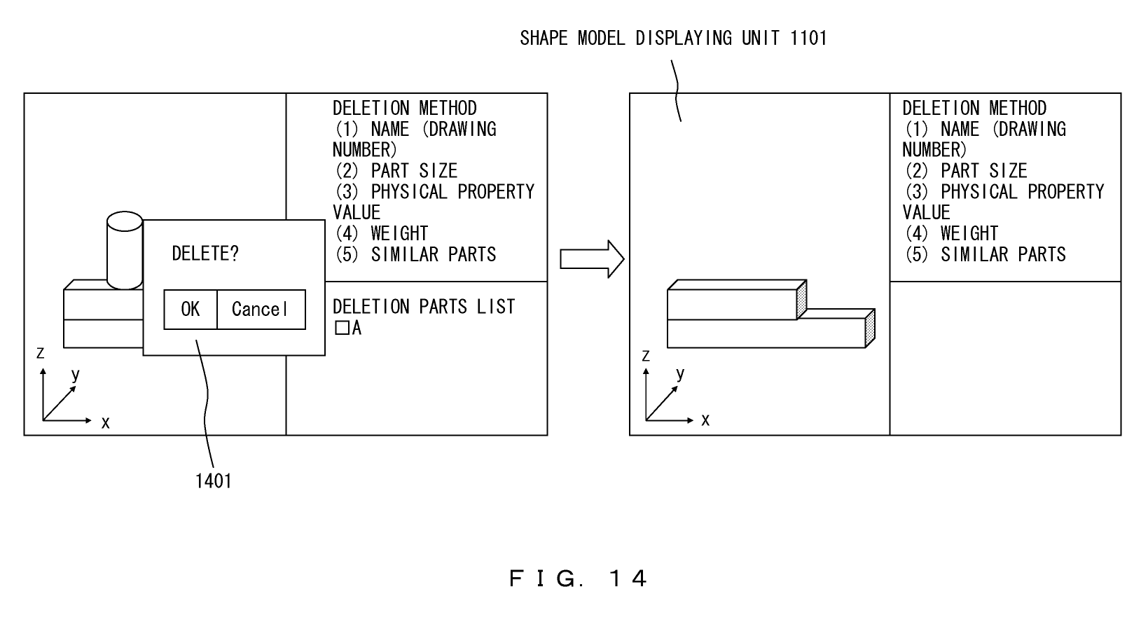

In S910 in FIG. 9, the GUI unit 506 displays, as illustrated in FIG. 14, a pop-up window 1401 for asking the system user whether the parts can be deleted as a final decision. When the system user has pressed the Cancel button, the process returns to S904. When the system user has pressed the OK button, in S911, the CAD part data deletion execution unit 508 deletes the corresponding CAD part data from the CAD part data storage unit 504, and stores remaining data in the analysis-model-producing CAD part data storage unit 509. When the deletion process is terminated, the GUI unit 506 hides, as illustrated in the shape model displaying unit 1101 in FIG. 14, the CAD part data that has been deleted.

The process to be performed when a method in which a deletion condition is specified by the name (or the drawing number) of a part is selected in S904 has been explained above. Next, explanations will be given, by referring to FIGS. 15 through 17, for the processes performed when a method in which a deletion condition is specified by the size of a part is selected in S904. Note that detailed explanations will be omitted for processes similar to those of the method of using the name of a part to specify a deletion condition.

In S1501 in FIG. 15, a deletion method in which a deletion condition is specified by the size of a part is selected.

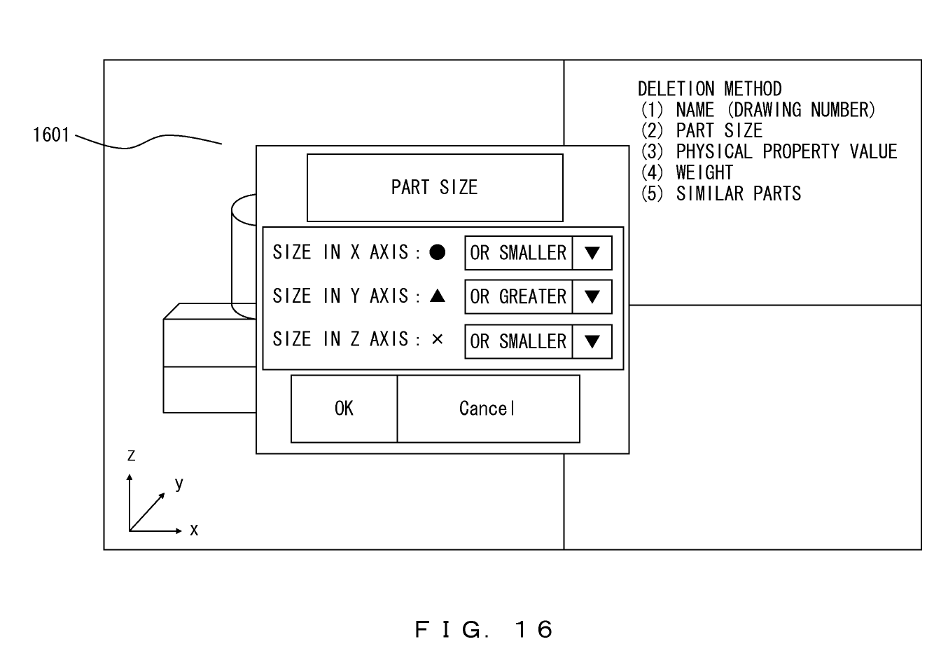

In S1502, a pop-up window 1601 for accepting the input of the size of a part is displayed as illustrated in FIG. 16, and the system user specifies the part size of CAD part data to be deleted. In the specifying, the user inputs the values in the X, Y, and Z directions, and also specifies whether parts equal to or greater than the input values are to be deleted, parts equal to or smaller than the input values are to be deleted, or specifies what percent of difference between the input values and actual parts allows the deletion. When the values are not input, the size in that direction is not specified. When the OK button is pressed after the input, the size of CAD part data specified as a deletion condition is stored in the CAD part data deletion method specifying unit 507, and the process proceeds to S1503. When the Cancel button is pressed in the pop-up window 1601, the process returns to S904.

In S1503 in FIG. 15, the CAD part data deletion execution unit 508 makes the CAD part data discrimination unit 505 extract, from the CAD part data storage unit 504, CAD part data meeting the condition stored in the CAD part data deletion method specifying unit 507. In the CAD part data discrimination unit 505, the part size information discrimination unit 702 searches the area containing “part size” in the CAD part data storage unit 504 illustrated in FIG. 6A in order to extract and output parts meeting the condition.

In S1504 in FIG. 15, it is determined whether or not there is a part corresponding to the input part size, and when there is not (No), the process proceeds to S1505, and the GUI unit 506 displays a message reporting that there is not a corresponding part, and the process returns to S1501. When there is a corresponding part (Yes), the process proceeds to S1506, and the GUI unit 506 displays the parts in a listed manner on the list display unit 1301 as shown in FIG. 13, and displays the corresponding CAD part data in a highlighted manner in the shape model 1103 in the shape model displaying unit 1101. Next, in S1507, the system user checks the boxes displayed in the list display unit 1301 in order to specify the parts to be deleted as a final decision. Then, the process proceeds to S910 in FIG. 9. The processes after this will not be explained because they are similar to those in the case of the method of specifying a deletion condition by the name of a part.

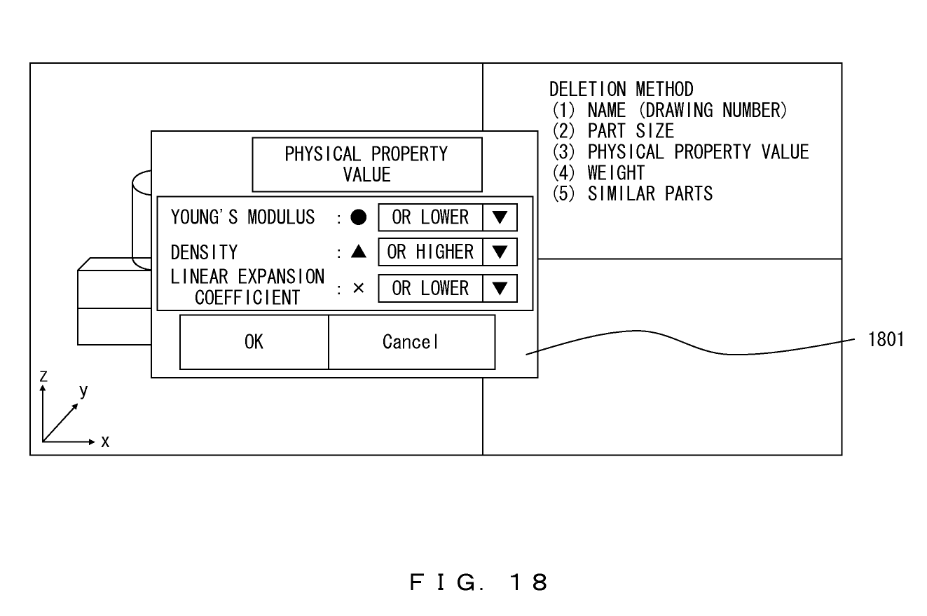

The processes performed when the method of specifying a deletion condition by the part size is selected in S904 have been explained above. Next, in S904, explanations will be given, by referring to FIGS. 17 and 18, for the processes when the method of specifying the deletion condition by the physical property value of a part is selected. Note that detailed explanations will be omitted for processes similar to those of the method of using the name of a part to specify a deletion condition.

In S1701 in FIG. 17, a method of specifying a deletion condition by the physical property value of a part is selected.

In S1702, a pop-up window 1801 for accepting the input of the physical property value of a part is displayed as illustrated in FIG. 18, and the system user specifies the physical property value of CAD part data to be deleted. In the specifying, the user inputs the physical property values such as a Young's modulus, density, and a linear expansion coefficient and also specifies whether parts equal to or higher than the input value are to be deleted, parts equal to or lower than the input value are to be deleted, or specifies what percent of difference between the input value and the actual property value would allow the deletion. When the value is not input, a deletion condition is not specified. When the OK button is pressed after the input, the physical property value of CAD part data specified as a deletion condition is stored in the CAD part data deletion method specifying unit 507, and the process proceeds to S1703. When the Cancel button is pressed in the pop-up window 1801, the process returns to S904.

In S1703 in FIG. 17, the CAD part data deletion execution unit 508 makes the CAD part data discrimination unit 505 extract, from the CAD part data storage unit 504, CAD part data meeting the condition stored in the CAD part data deletion method specifying unit 507. In the CAD part data discrimination unit 505, the physical property value information discrimination unit 703 searches the area containing “physical property value” in the CAD part data storage unit 504 illustrated in FIG. 6A. When a physical property value is not stored in the area containing physical property values in the CAD part data storage unit 504, the process proceeds from S1704 to S1705, and the GUI unit 506 displays in the window a message reporting that “physical property value of CAD part data is not stored”, and the process returns to S904.

When the process has proceeded from S1704 to S1706 in FIG. 17, CAD part data that corresponds to the physical property value input as a deletion condition is detected. When there is no data that corresponds to the condition, the process proceeds to S1707, and a message reporting that “There is no corresponding part data” is displayed, and thereafter the process returns to S1701. When there is corresponding data, the process proceeds to S1708, where the GUI unit 506 lists the data in the list display unit 1301 as illustrated in FIG. 13, and the corresponding CAD part data is displayed in a highlighted manner on the shape model 1103 displayed in the shape model displaying unit 1101. Then, the system user checks the boxes displayed in the list display unit 1301 in S1709 to specify the parts to be deleted as a final decision. Thereafter, the process proceeds to S910 in FIG. 9. The processes after this will not be explained because they are similar to those in the case of the method of specifying a deletion condition by the name of a part.

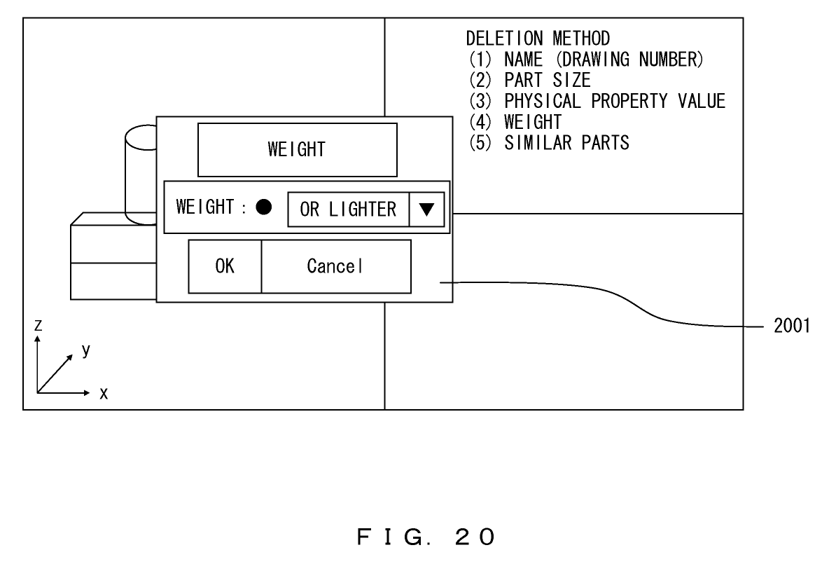

The processes performed when the method of specifying a deletion condition by the physical property value is selected in S904 have been explained above. Next, explanations will be given, by referring to FIGS. 19 and 20, for the processes performed when the method of specifying the deletion condition by the weight of a part is selected in S904. Note that detailed explanations will be omitted for processes similar to those of the method of using the name of a part to specify a deletion condition.

In S1901 in FIG. 19, a method in which a deletion method is specified by the weight value of a part is selected.

In S1902, a pop-up window 2001 for accepting the input of the weight value of a part is displayed as illustrated in FIG. 20, and the system user specifies the weight value of CAD part data to be deleted. In the specifying, the user inputs the weight value, and also specifies whether parts equal to or heavier than the input value are to be deleted, parts equal to or lighter than the input value are to be deleted, or specifies what percent of difference between the input weight value and the weight of actual parts allows the deletion. When the OK button is pressed after the input, the weight value of CAD part data specified as a deletion condition is stored in the CAD part data deletion method specifying unit 507, and the process proceeds to S1903. When the Cancel button is pressed in the pop-up window 2001, the process returns to S904.

In S1903 in FIG. 19, the CAD part data deletion execution unit 508 makes the CAD part data discrimination unit 505 extract, from the CAD part data storage unit 504, CAD part data meeting the condition stored in the CAD part data deletion method specifying unit 507. In the CAD part data discrimination unit 505, the weight information discrimination unit 704 searches the area containing “weight” in the CAD part data storage unit 504 illustrated in FIG. 6A. When a weight value is not stored in the area containing weight values in the CAD part data storage unit 504, the process proceeds from S1904 to S1905, and the GUI unit 506 displays in the window a message reporting that “Weight value of CAD part data is not stored”, and the process returns to S904.

When the process has proceeded from S1904 to S1906 in FIG. 19, CAD part data that corresponds to the weight value input as a deletion condition is detected. When there is no data that corresponds to the condition, the process proceeds to S1907, and a message reporting that “There is no corresponding part data” is displayed, and thereafter the process returns to S1901. When there is corresponding data, the process proceeds to S1908, where the GUI unit 506 lists the data in the list display unit 1301 as illustrated in FIG. 13, and the corresponding CAD part data is displayed in a highlighted manner in the shape model 1103 displayed in the deletion method specifying unit 1101. Then, the system user checks the boxes displayed in the list display unit 1301 in S1909 to specify parts to be deleted as a final decision. Thereafter, the process proceeds to S910 in FIG. 9. The processes after this will not be explained because they are similar to those in the case of the method of specifying a deletion condition by the name of a part.

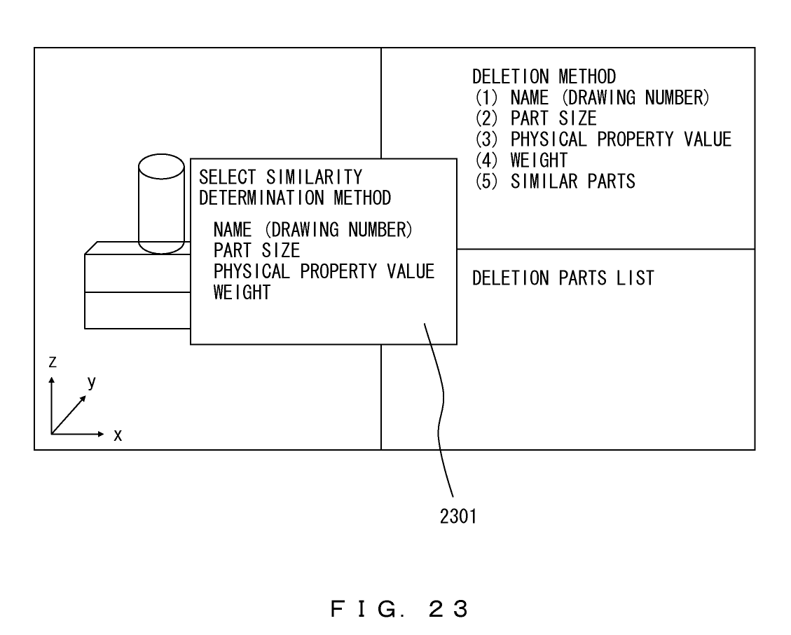

The processes performed when the method of specifying a deletion condition by a weight value is selected in S904 have been explained above. Next, explanations will be given, by referring to FIGS. 21 and 23, for the processes when the method of specifying the deletion condition by a similar part is selected in S904. Note that detailed explanations will be omitted for processes similar to those of the method of using the name of a part to specify a deletion condition.

In S2101 in FIG. 21, a deletion method in which a deletion condition is specified by a similar part is selected.

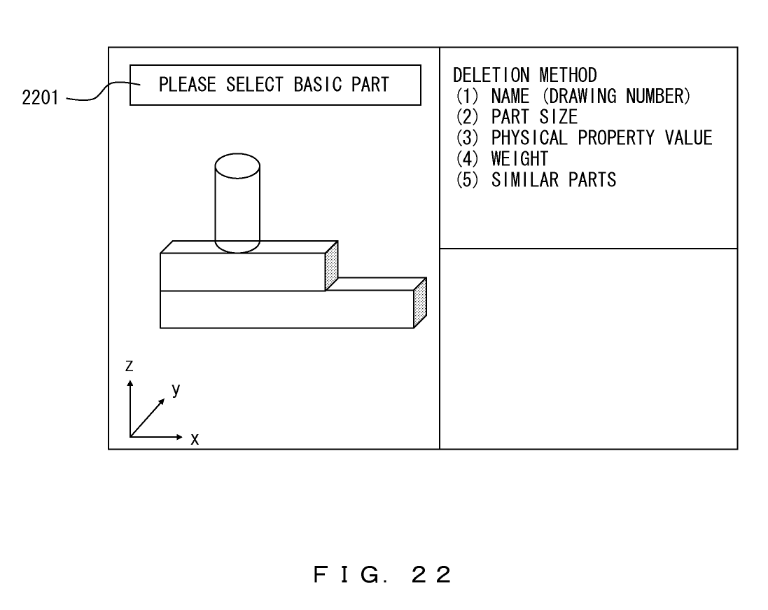

In S2102, the GUI unit 506 displays a message 2201 instructing “Please select a base part” for example as illustrated in FIG. 22. When a base part is specified, the CAD part data is displayed in a highlighted manner, and information values of the respective factors of the basic CAD part data specified as a deletion condition are stored in the CAD part data deletion method specifying unit 507 in S2103.

In S2104, the GUI unit 506 displays a pop-up window 2301 as illustrated in FIG. 23 in order to prompt the system user to specify whether similarity in name, similarity in part size, similarity in physical property value, or similarity in weight is the deletion condition. The system user selects and specifies one of the similarity determination methods displayed in the pop-up window 2301.

When similarity in name is specified as a deletion condition in S2104, the process proceeds to S2105. In S2105, the name input area in the pop-up window 1201 in FIG. 12 displays the name of the base part input in that area (S1002), and thereafter, processes similar to those in FIG. 10 are performed.

When similarity in part size is specified as a deletion condition in S2104, the process proceeds to S2106. In S2106, the part size input area in the pop-up window 1601 illustrated in FIG. 16 displays the values in the X, Y, and Z directions of the base part input in that area (S1502). The system user specifies whether parts equal to or greater than the input values are to be deleted or parts equal to or smaller than the input values are to be specified. Thereafter, processes similar to those in FIG. 15 are performed.

When similarity in physical property value is specified as a deletion condition in S2104, the process proceeds to S2107. In S2107, the physical property value input area in the pop-up window 1801 in FIG. 18 displays the respective physical property values of the base part input in that area (S1702). The system user specifies whether parts equal to or higher in physical property values than the input values are to be deleted or whether parts equal to or lower in physical property values than the input values are to be specified. Thereafter, processes similar to those in FIG. 17 are performed.

When similarity in weight is specified as a deletion condition in S2104, the process proceeds to S2108.

In S2108, the weight input area in the pop-up window 2001 illustrated in FIG. 20 displays the weight value of the base part input in that area (S1902). The system user specifies whether parts equal to or heavier than the input value are to be deleted or parts equal to or lighter than the input value are to be deleted, and thereafter the processes similar to those in FIG. 19 are performed.

After the processes in S2105, S2106, S2107, and S2108, the process proceeds to S910 in FIG. 9, and the corresponding data is deleted.

The processes performed when the method of specifying a deletion condition by a similar part is selected in S904 have been explained above.

Hereinabove, FIGS. 1 through 23 have been referred to in order to give detailed explanations for an analysis-model-producing apparatus according to the present invention. However, the scope of the present invention is not limited to the above described analysis-model-producing apparatus and the present invention can be implemented as functions included in a CAD system, and also can be implemented as a software program operating on an information processing apparatus such as a computer.

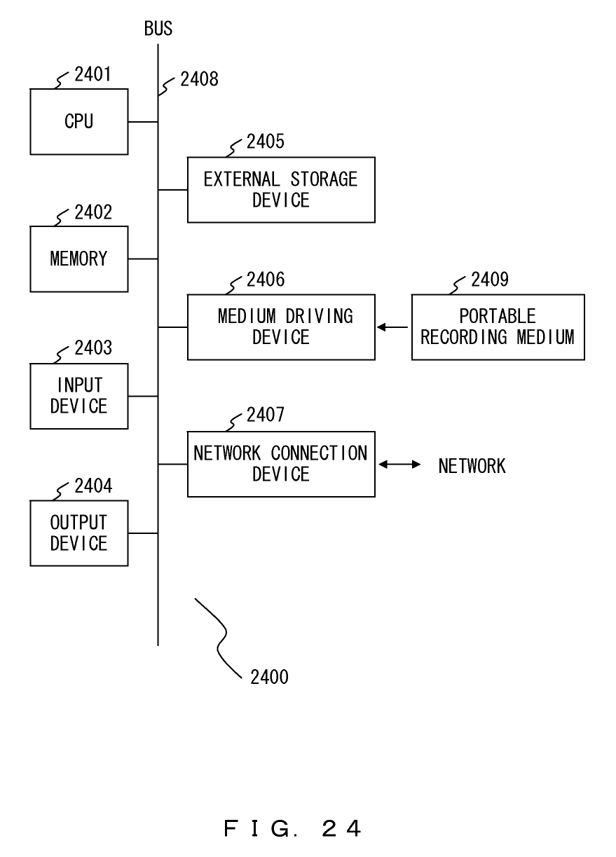

FIG. 24 illustrates a hardware configuration of an information processing apparatus that implements an analysis-model-producing apparatus according to the present invention.

An information processing apparatus 2400 includes a CPU 2401, memory 2402, an input device 2403, an output device 2404, an external storage device 2405, a medium driving device 2406, and a network connection device 2407, and they are connected to each other via a bus 2408.

Examples of the memory 2402 are ROM (Read Only Memory), RAM (Random Access Memory), and the like, and they store programs and data for implementing the analysis-model-producing apparatus.

The CPU 2401 executes programs using the memory 2402 in order to implement the analysis-model-producing apparatus.

Examples of the input device 2403 are a keyboard, a pointing device, a touch panel, and the like, and they are used for inputting instructions and information from users. Examples of the output device 2404 are a display device, a printer, and the like, and they are used by the information processing apparatus 2400 to inquire with users or to output processing results or the like.

Examples of the external storage device 2405 are a magnetic disk device, an optical disk device, a magneto-optical disk device, and the like. It is also possible to store programs and data in this external storage device 2405 in order to load them onto the memory 2402 when they are being used.

The medium driving device 2406 drives a portable recording medium 2409 in order to access storage content in the portable recording medium 2409. As the portable recording medium 2409, an arbitrary computer readable recording medium such as a memory card, a memory stick, a flexible disk, a CD-ROM (Compact Disc Read Only Memory), an optical disk, a magneto-optical disk, a DVD (Digital Versatile Disk), or the like is used. It is also possible to store programs and data in this portable recording medium 2409 in order to load them onto the memory 2402 when they are being used.

The network connection device 2407 communicates with an external device via an arbitrary network (circuit) such as a LAN, a WAN, or the like so as to exchange data with it for communication. It is also possible to receive programs and data from an external device to load them onto the memory 2402 when they are being used.

A program operating on the information processing apparatus is configured to use the memory 2402 and the like in the information processing apparatus in order to execute the processes in the flowcharts in FIGS. 9, 10, 15, 17, 19, and 21, or is configured to operate the GUI to display the windows as illustrated in FIGS. 8, 11, 12, 13, 14, 16, 18, 20, and 22.

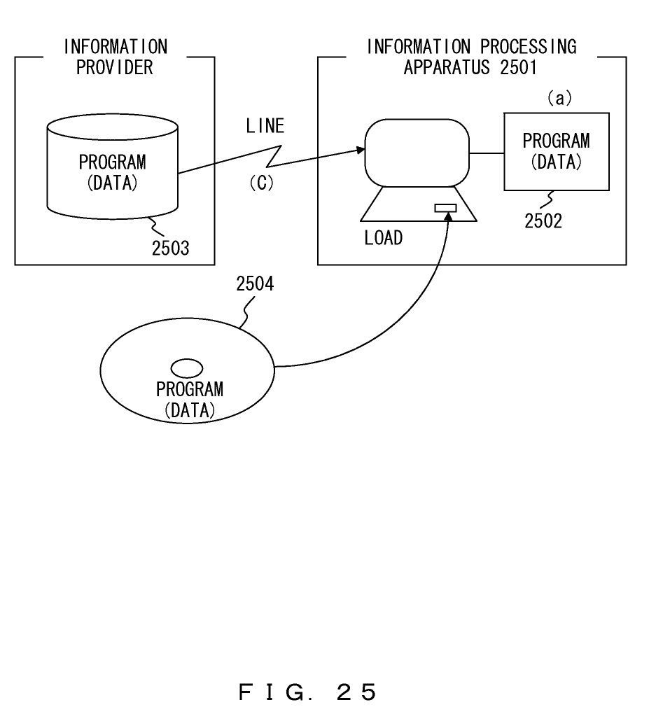

FIG. 25 illustrates a method of loading a program onto the information processing apparatus. This method is used when the analysis-model-producing apparatus according to the present invention is implemented by the execution of the program on the information processing apparatus.

FIG. 25(a) illustrates a method by which an information processing apparatus 2501 loads programs and data 2502 stored in an external storage device such as a hard disk in the information processing apparatus 2501.

FIG. 25(b) illustrates a method in which programs and data 2504 stored in a portable storage medium such as a CD-ROM or a DVD are loaded via a media driving device in the information processing apparatus 2501.

FIG. 25(c) illustrates a method in which programs and data 2503 provided through a circuit such as a network by an information provider are loaded via a communication device in the information processing apparatus 2501.

As has been described, the present invention can be implemented as a program for causing information processing apparatuses such as a computer to implement functions similar to those in the above described systems. Also, the present invention can be configured as a computer readable portable recording medium that has stored a program for causing an information processing apparatus such as a computer to implement functions similar to the above described functions. Also, the present invention can be configured as a computer data signal embodied in the form of a carrier wave to express the above program.

According to an analysis-model-producing apparatus of the present invention, it is possible to specify a condition for deleting unnecessary geometric shape data, in accordance with the content of a numerical analysis, from geometric shape data constituting a shape model, and also to extract only necessary geometric shape data in accordance with the specified condition. Thereby, efficiency can be increased in operations, performed by the system users, of deleting unnecessary geometric shape data from a shape model for producing an analysis model. Also, a sufficient period of time can be secured for performing a numerical analysis so that reliability of products such as structures can be increased.

All examples and conditional language recited herein intended for pedagogical purposes to aid the reader in understanding the invention and the concepts contributed by the inventor to furthering art, and are to be construed as being without limitation to such specifically recited example and conditions, nor does the organization of such examples in the specification relate to a showing of the superiority and inferiority of the invention. Although the embodiment(s) of the present invention have been described in detail, it should be understood that the various changes, substitutions, and alterations could be made hereto without departing from the spirit and scope of the invention.

What is claimed is:

1. An analysis-model-producing apparatus including a first storage unit for storing at least one piece of geometric shape data constituting a shape model, and a second storage unit for storing at least one piece of geometric shape data for producing an analysis model, comprising:
geometric shape data deletion method specifying means for specifying a deletion method for deleting, from the geometric shape data stored in the first storage unit, geometric shape data that is unnecessary to production of an analysis model; and
geometric shape data deletion execution means for deleting, using the specified deletion method, unnecessary data from the geometric shape data stored in the first storage unit, and storing remaining geometric shape data in the second storage unit.

2. The analysis-model-producing apparatus according to claim 1, wherein:
the geometric shape data includes at least one of name, size, a physical property value, weight, and positional coordinates.

3. The analysis-model-producing apparatus according to claim 2, further comprising:
geometric shape data input means for inputting, into the analysis-model-producing apparatus, geometric shape data constituting a shape model; and
assembly connection adjustment means for adjusting the input geometric shape data so that connections between the respective pieces of geometric shape data are maintained, and storing the data in the first storage unit.

4. The analysis-model-producing apparatus according to claim 3, wherein:
the assembly connection adjustment means converts, into an absolute coordinates expression, positional coordinates that are expressed as relative coordinates among positional coordinates included in the geometric shape data.

5. The analysis-model-producing apparatus according to claim 2, wherein:
the geometric shape data deletion method specifying means specifies, as a deletion method, one of a deletion method based on name, a deletion method based on size, a deletion method based on a physical property value, a deletion method based on weight, and a deletion method for deleting similar geometric shape data.

6. The analysis-model-producing apparatus according to claim 5, wherein:
when the deletion method based on name is specified by the geometric shape data deletion method specifying means, the geometric shape data deletion execution means executes either a process of deleting geometric shape data that completely corresponds in name or a process of deleting geometric shape data that partially corresponds in name, from the geometric shape data stored in the first storage unit.

7. The analysis-model-producing apparatus according to claim 5, wherein:
when the deletion method based on size is specified by the geometric shape data deletion method specifying means, the geometric shape data deletion execution means executes a process of deleting geometric shape data that corresponds to values in an X direction and/or a Y direction and/or a Z direction specified as a deletion condition, from the geometric shape data stored in the first storage unit.

8. The analysis-model-producing apparatus according to claim 5, wherein:
when the deletion method based on a physical property value is specified by the geometric shape data deletion method specifying means, the geometric shape data deletion execution means executes a process of deleting geometric shape data that corresponds to a physical property value specified as a deletion condition, from the geometric shape data stored in the first storage unit.

9. The analysis-model-producing apparatus according to claim 8, wherein:
the physical property value includes at least one of a Young's modulus, density, and a coefficient of thermal expansion.

10. The analysis-model-producing apparatus according to claim 5, wherein:
when the deletion method based on weight is specified by the geometric shape data deletion method specifying means, the geometric shape data deletion execution means executes a process of deleting geometric shape data that corresponds to a weight value specified as a deletion condition, from the geometric shape data stored in the first storage unit.

11. The analysis-model-producing apparatus according to claim 5, wherein:
when the deletion method for deleting similar geometric shape data is specified by the geometric shape data deletion method specifying means, the geometric shape data deletion execution means executes a process of deleting corresponding geometric shape data on the basis of a specified basic geometric shape data and on the basis of one of name, size, a physical property value, or weight specified as a similarity factor for deleting data, from the geometric shape data stored in the first storage unit.

12. A method of producing an analysis model in an information processing apparatus including a first storage unit for storing at least one piece of geometric shape data constituting a shape model and a second storage unit for storing at least one piece of geometric shape data for producing an analysis model, comprising:
a step of specifying a deletion method for deleting, from the geometric shape data stored in the first storage unit, geometric shape data that is unnecessary to production of an analysis model; and
a step of deleting, using the specified deletion method, unnecessary data from the geometric shape data stored in the first storage unit, and storing remaining geometric shape data in the second storage unit.

13. A computer readable recording medium that has recorded an analysis-model-producing program for causing an information processing apparatus including a first storage unit for storing at least one piece of geometric shape data constituting a shape model and a second storage unit for storing at least one piece of geometric shape data for producing an analysis model, to function as
geometric shape data deletion method specifying means for specifying a deletion method for deleting, from the geometric shape data stored in the first storage unit, geometric shape data that is unnecessary to production of an analysis model;
geometric shape data deletion execution means for deleting, using the specified deletion method, unnecessary data from the geometric shape data stored in the first storage unit, and storing remaining geometric shape data in the second storage unit; and
analysis-model-producing means for producing an analysis model from the geometric shape data stored in the second storage unit.
